(19) United States
(12) Patent Application Publication
(10) Pub. No.: US 2002/0175922 A1
(43) Pub. Date: Nov. 28, 2002

(54) Method and apparatus for eliminating flicker in plasma display panel

(75) Inventors: Bon Cheol Koo, Taegu-shi (KR); Seong Cheol Shin, Taegu-shi (KR)

Correspondence Address: FLESHNER & KIM, LLP, P.O. Box 221200, Chantilly, VA, 20153-1200, US

(73) Assignee: LG Electronics Inc.

(21) Appl. No.: 10/151,929

(22) Filed: May 22, 2002

(30) Foreign Application Priority Data
May 23, 2001 (KR) P2001-28519

(51) Int. Cl. G09G 5/02

(52) U.S. Cl. 345/589

(57) ABSTRACT

A flicker-eliminating method and apparatus for a plasma display panel that is capable of eliminating a flicker phenomenon caused by a different maximum light-emission time. In the method and apparatus, at least two modes in which at least one of said brightness weighting value and the number of said sub-fields are different from each other are established. The sub-field given by the maximum brightness weighting value is arranged at an initial part of the frame in each of said modes.

### BACKGROUND OF THE INVENTION

1. Field of the Invention

This invention relates to a driving method and apparatus for a plasma display panel, and more particularly to a flicker-eliminating method and apparatus for a plasma display panel that is capable of eliminating a flicker phenomenon caused by a different maximum light-emission time.

2. Description of the Related Art

Generally, a plasma display panel (PDP) radiates a phosphor layer using an ultraviolet with a wavelength of 147 nm generated upon discharge of an inactive mixture gas such as He+Xe, Ne+Xe or He+Ne+Xe, to thereby display a picture including characters and graphics. Such a PDP is easy to be made into a thin-film and large-dimension type. Moreover, the PDP provides a very improved picture quality owing to a recent technical development. Particularly, since a three-electrode, alternating current (AC) surface-discharge PDP has wall charges accumulated in the surface thereof upon discharge and protects electrodes from a sputtering generated by the discharge, it has advantages of a low-voltage driving and a long life.

Referring to FIG. 1, a discharge cell of a conventional three-electrode, AC surface-discharge PDP includes a scan/sustain electrode 12Y and a common sustain electrode 12Z provided on an upper substrate 11, and an address electrode 17X provided on a lower substrate 16.

The scan/sustain electrode 12Y and the common sustain electrode 12Z are formed from a transparent electrode material, such as indium-tin-oxide (ITO). Each of the scan/sustain electrode 12 and the common sustain electrode 12Z is provided with a metal bus electrode 13 for reducing a resistance.

An upper dielectric layer 14 and a protective layer 15 are disposed on the upper substrate 11 provided with the scan/sustain electrode 12Y and the common sustain electrode 12Z. The protective layer 15 prevents a damage of the upper dielectric layer 14 caused by a sputtering during the plasma discharge and improves the emission efficiency of secondary electrons. This protective layer is usually made from magnesium oxide (MgO).

A lower dielectric layer 18 and barrier ribs 19 are formed on the lower substrate 18 provided with the address electrode 17X. The surfaces of the lower dielectric layer and the barrier ribs 19 are coated with a fluorescent material layer 20. The address electrode 17X is formed in a direction crossing the scan/sustain electrode 12Y and the common sustain electrode 13Z.

The barrier ribs 19 is formed in a direction parallel to the address electrode 17X to prevent an ultraviolet ray and a visible light generated by the discharge from being leaked to the adjacent discharge cells. The fluorescent material layer 20 is excited by an ultraviolet ray generated upon plasma discharge to produce any one of red, green and blue visible lights. An inactive mixture gas such as He+Xe or Ne+Xe is injected into a discharge space defined between the upper and lower substrate 11 and 16 and the barrier rib 19.

In order to express gray levels of a picture, such a PDP is driven by dividing one frame into various sub-fields having a different discharge frequency. Each sub-field is again divided into a reset period for causing a uniform discharge, an address period for selecting a discharge cell and a sustain period for implementing gray levels depending upon a discharge frequency. For instance, when it is intended to display a picture of 256 gray levels, a frame interval equal to 1/60 second (i.e. 16.67 ms) is divided into 8 sub-fields. Each of the 8 sub-fields is again divided into an address period and a sustain period. Herein, the reset period and the address period of each sub-field are equal every sub-field, whereas the discharge frequency is increased at a ration of 2ⁿ (wherein n=0, 1, 2, 3, 4, 5, 6 and 7) for each sub-field. As described above, the sustain period becomes different at each sub-field, so that it is possible to express gray levels of a picture.

The PDP may generate a pseudo contour noise from a moving picture because of its characteristic of implementing a gray scale of a picture by a combination of sub-fields. If a pseudo contour noise is generated, then a pseudo contour emerges on the field to deteriorate a display quality.

For instance, if the field is moved to the right after the left half of the field was displayed by 127 gray level values and the right half of the field was displayed by 128 gray level values as shown in FIG. 2 and FIG. 3, then an eye of an observer views a light diverged from the adjacent two pixels at a boundary portion at the same time. Thus, a peak white or a white band emerges at the boundary portion between the gray level values 127 and 128. To the contrary, if the field, the left half of which is displayed by 128 gray level values and the right half of which is displayed by 127 gray level values, is moved to the right, then a black level or a black band emerges at a boundary portion between the gray level values 128 and 127.

Strategies for eliminating such a moving picture pseudo contour noise include a scheme of dividing one sub-field to add 1 or 2 sub-fields, a scheme of re-arranging a sequence of sub-fields, a scheme of adding sub-fields and re-arranging a sequence of sub-fields, and an error diffusion method, etc.

A method of utilizing modes having a different number of sub-fields and a different brightness weighting value, of the strategies of eliminating a moving picture pseudo contour noise, will be described below.

Referring to FIG. 4, ‘A’ mode has eight sub-fields SF1 to SF8, each of which has a brightness weighting value set to decimal numbers 1, 2, 4, 8, 16, 32, 64 or 128. ‘B’ mode has nine sub-fields SF1 to SF9, each of which has a brightness weighting value set to decimal numbers 1, 2, 4, 8, 16, 32, 64, 128 or 256. If sub-field emission patterns in the ‘A’ and ‘B’ modes are changed to display an image, then an eye of an observer less recognizes a moving picture pseudo contour noise than when an image is displayed only in any one mode.

However, A picture display in several modes as shown in FIG. 4 raises a problem in that, since the sub-fields given by the maximum brightness weighting value for each mode are different from each other on the time axis, a flicker is generated. In FIG. 4, the sub-field given by the maximum brightness weighting value of ‘128’ in the ‘A’ mode is the ninth sub-field SF8 while the sub-field given by the maximum brightness weighting value of ‘256’ in the ‘B’ mode is the ninth sub-field SF9. Accordingly, the maximum emission time C1 when a picture is displayed in the ‘A’ mode is different from the maximum emission time C2 when a picture is displayed in the ‘B’ mode. Further, the maximum brightness weighting value in the ‘A’ mode is different from that in the ‘B’ mode. Since the maximum emission times C1 and C2 for each mode are different from each other on the time axis and a brightness difference between the fields is large, a flicker becomes serious.

Referring to FIG. 5, in the three modes of ‘A’, ‘B’ and ‘C’ modes, the number of sub-fields is set differently. Also, the three modes ‘A’, ‘B’ and ‘C’ are arranged at the earlier side on the time axis as they are a sub-field having a lower brightness weighting value, whereas they are arranged at the later side on the time axis as they are a sub-field having a higher brightness weighting value. In each mode, the sub-field having the maximum brightness weighting value is the tenth sub-field SF10 in the ‘A’ mode, the eleventh sub-field SF11 in the ‘B’ mode, and the twelfth sub-field SF12 in the ‘C’ mode. As a result, the maximum emission time C1, C2 and C3 in the three modes become different from each other within the vertical synchronizing interval Vsync to cause a generation of flicker.

In order to reduce an abnormal brightness variation of the field caused by such a different maximum emission time in each mode, that is, a flicker, Korea Laid-open Patent Gazette No. 10-2000-0070527, published on Nov. 25, 2000, has been suggested a scheme of according the maximum emission time using a data source for storing an emission time data of a sub-field given by the maximum brightness weighting value, means for selecting the emission time data of the sub-field given by the most significant brightness weighting value, delay time calculating means for arranging the sub-field given the most significant weighting value on a basis of the emission time data, and delay means for arranging the sub-field given by the most significant weighting value at a position determined in advance. However, such a scheme has a problem in that it not only requires an addition of the data source for storing an emission time data, the data selecting means, the delay time calculating means and the delay means to thereby increase a complexity of the hardware and hence the manufacturing cost, but also requires an algorithm for calculating a delay time.

In the mean time, the flicker phenomenon also appears when the sub-field is arranged with being given by the maximum brightness weighting value on a random basis so as to reduce a moving picture pseudo contour noise rather than being arranged in a sequence going from a lower brightness weighting value into a higher brightness weighting value.

### SUMMARY OF THE INVENTION

Accordingly, it is an object of the present invention to provide a flicker-eliminating method and apparatus for a plasma display panel that is capable of eliminating a flicker phenomenon caused by a different maximum light-emission time.

In order to achieve these and other objects of the invention, a flicker-eliminating method for a plasma display panel according to one aspect of the present invention includes steps of setting at least two modes in which at least one of a brightness weighting value and the number of sub-fields is different from each other; and arranging said sub-field given by the maximum brightness weighting value at an initial part of the frame in each of said modes.

In the flicker-eliminating method, sub-fields other than said sub-field given by the maximum brightness weighting value is arranged at a sequence having lower weighting values in each of said modes.

Alternatively, sub-fields other than said sub-field given by the maximum brightness weighting value have brightness weighting values arranged on a random basis.

A flicker-eliminating apparatus for a plasma display panel according to another aspect of the present invention includes a sub-field mapping unit for mapping an input data using at least two modes in which at least one of a brightness weighting value and the number of sub-fields is different from each other and the sub-field given by the maximum brightness weighting value is arranged at an initial part of the frame; and said plasma display panel for displaying a data supplied from the sub-field mapping unit.

In the flicker-eliminating apparatus, sub-fields other than said sub-field given by the maximum brightness weighting value is arranged at a sequence having lower weighting values in each of said modes.

Alternatively, sub-fields other than said sub-field given by the maximum brightness weighting value have brightness weighting values arranged on a random basis.

### BRIEF DESCRIPTION OF THE DRAWINGS

These and other objects of the invention will be apparent from the following detailed description of the embodiments of the present invention with reference to the accompanying drawings, in which:

FIG. 1 is a perspective view showing a structure of a discharge cell of a conventional three-electrode, AC surface-discharge plasma display panel;

FIG. 2 schematically depicts a moving object being moved beyond a boundary between different gray level areas and an eye of an observer tracing the moving object in a moving picture;

FIG. 3 depicts a phenomenon that a pseudo contour noise appears from the moving picture as shown in FIG. 2;

FIG. 4 shows an inconsistency of the maximum emission time at frames in the ‘A’ and ‘B’ modes arranged such that a brightness relative ratio is different and the number of sub-fields is different;

FIG. 5 shows an inconsistency of the maximum emission time in each of three modes arranged such that a brightness relative ratio is different and the number of sub-fields is different;

FIG. 6 is a block diagram showing a configuration of a flicker-eliminating apparatus for a plasma display panel according to an embodiment of the present invention; and

FIG. 7 represents the maximum emission time in each mode of the flicker-eliminating apparatus for the plasma display panel as shown in FIG. 6.

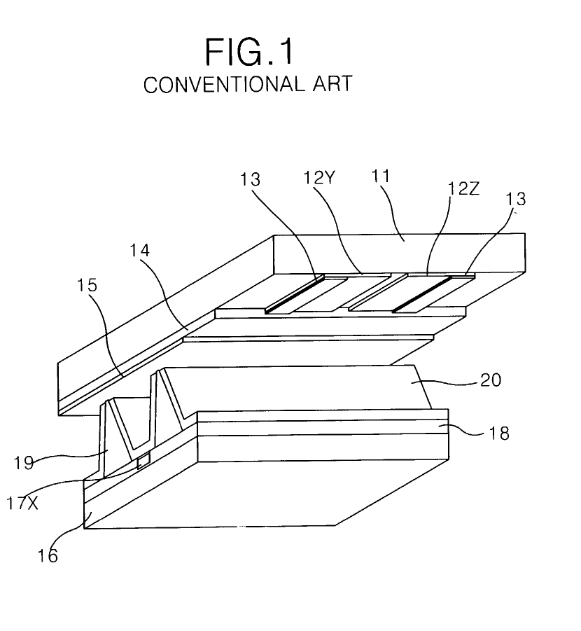

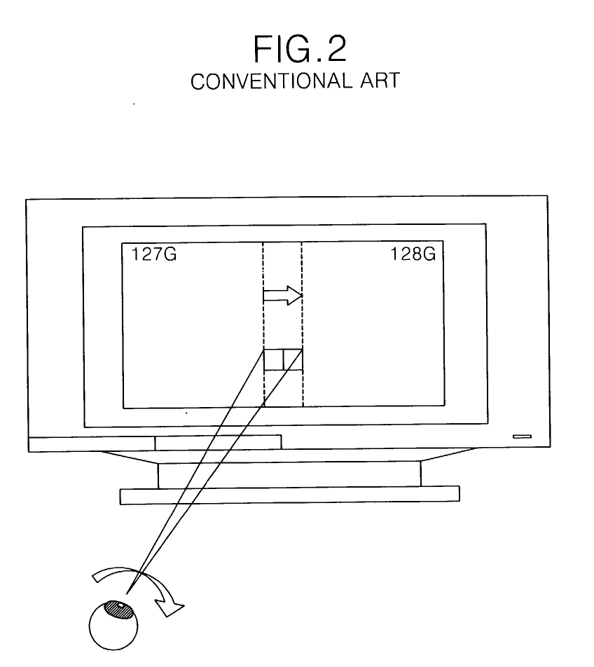

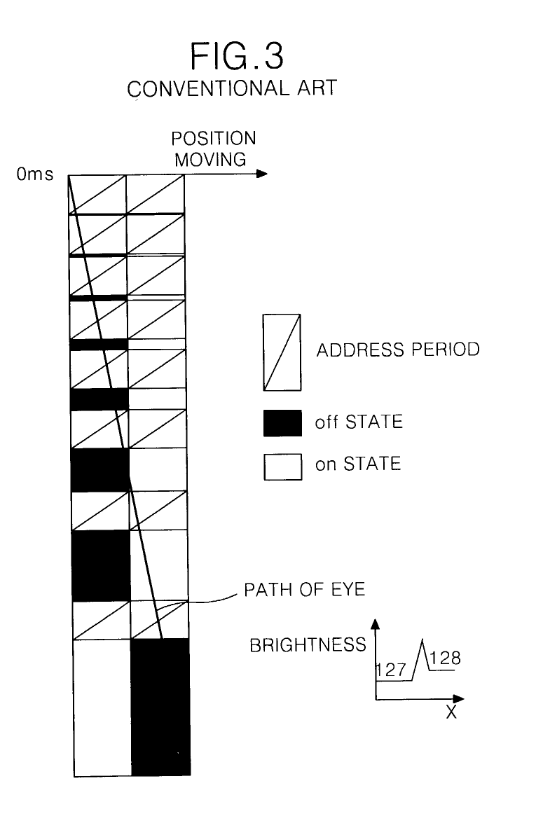

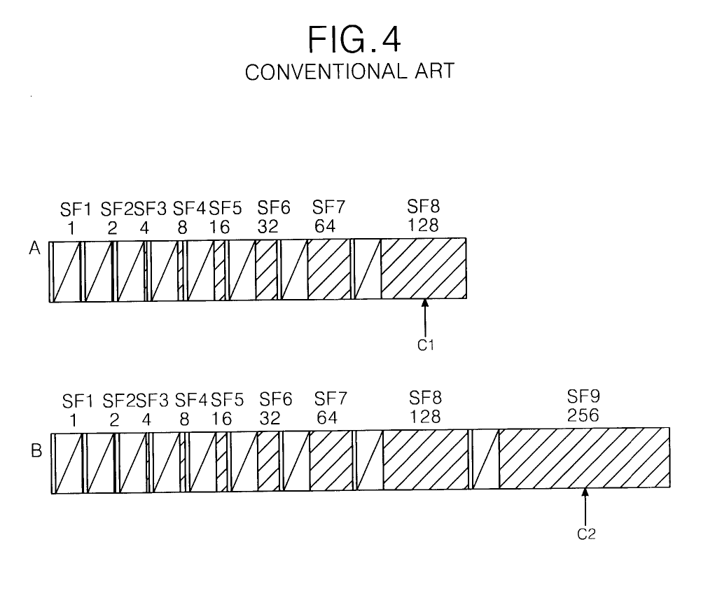

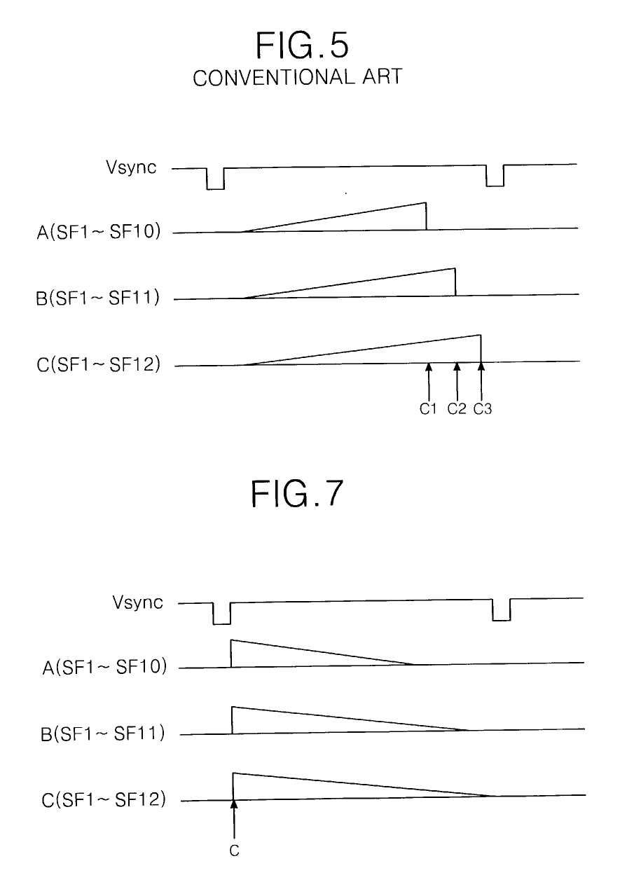

### DETAILED DESCRIPTION OF THE PREFERRED EMBODIMENT

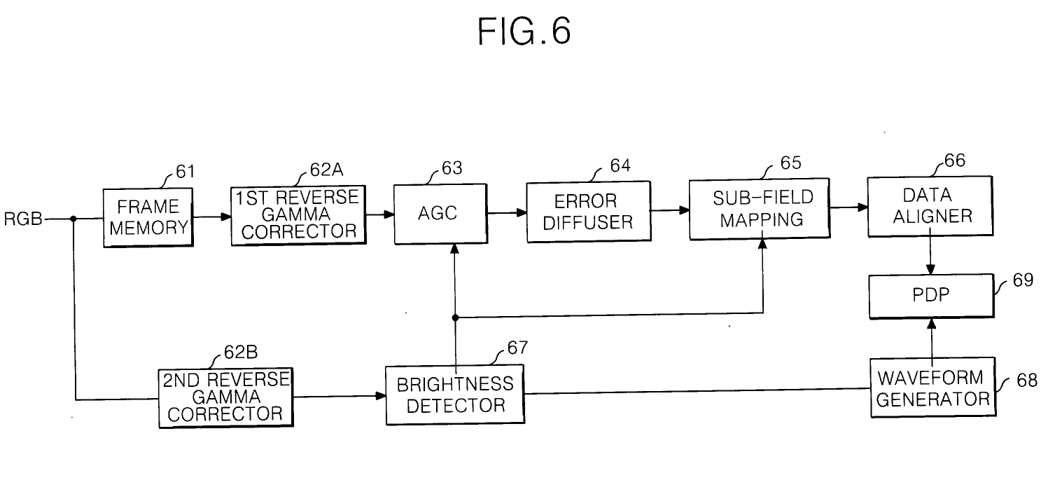

Referring to FIG. 6, a driving apparatus for a plasma display panel (PDP) according to an embodiment of the present invention includes a frame memory 61 connected to an input line of data RGB, a first reverse gamma corrector 62A, an automatic gain controller 63, an error diffuser 64, a sub-field mapping unit 65 and a data aligner 66 that are connected between the frame memory 61 and the PDP 69, and a second reverse gamma corrector 62B, a brightness detector 67 and a waveform generator 68 that are connected between the input line of data RGB and the PDP 69.

The frame memory 61 stores data RGB for one frame and supplies the stored data to the first reverse gamma corrector 62A. The first reverse gamma corrector 62A makes a reverse gamma correction of a gamma-corrected image signal applied from the frame memory 61 to linearly change the brightness according to a gray level value of the image signal.

The automatic gain controller 63 is connected between the first reverse gamma corrector 62A and the brightness detector 67 to convert a gray level range of the input data RGB into a pre-determined gray level range depending upon a brightness information from the brightness detector 67. For example, if a gray level range established in advance is more than 256, then the input data RGB having 256 gray levels is sub-divided into a pre-determined gray level range.

The error diffuser 64 plays a role to diffuse an error component of the cell into the adjacent cells to make a fine control of a brightness value. To this end, the error diffuser 64 divides the data from the first reverse gamma corrector 62A into an integer part and a decimal fraction part and multiplies the decimal fraction part by a Floy-Steinberg coefficient to thereby diffuse an error into the adjacent cells.

The sub-field mapping unit 66 divides the data from the error diffuser 65 for each bit and maps the data divided for each bit such that each of the sub-fields given by the maximum brightness weighting value is arranged at the first part of the frame. The data aligner 66 plays a role to convert an image data inputted from the sub-field mapping unit 69 to be suitable for a resolution format of the PDP 69, thereby applying the converted image data to an address driving integrated circuit (IC) of the PDP 69.

The second reverse gamma corrector 62B makes a reverse gamma correction of a gamma-corrected data from the input line to apply it to the brightness detector 67. The brightness detector 67 calculates a brightness average value every frame using a frame memory (not shown) and then applies it to the sub-field mapping unit 65 for the purpose of controlling the sub-field mapping unit 65. The sub-field mapping unit 65 selects a mode such that a pseudo contour noise dose not emerge from a moving picture in accordance with a brightness average value of the frame applied from the brightness detector 67.

The waveform generator 68 generates a timing control signal for generating set-up and set-down waveforms, a scanning waveform and a sustaining waveform in the reset period, and applies the timing control signal to an address driving IC, a scan driving IC and a sustain driving IC for driving the address electrode, the scan/sustain electrode and the common sustain electrode fo the PDP 69, respectively.

Referring to FIG. 7, the flicker-eliminating apparatus for the PDP according to the embodiment of the present invention displays an image in three modes, that is, ‘A’, ‘B’ and ‘C’ modes in which the number of sub-fields in which a data is mapped by the sub-field mapping unit 65 consists of 10 (SF1 to SF10), 11 (SF1 to SF11) and 12 (SF1 to SF12), respectively.

In each of the ‘A’, ‘B’ and ‘C’ modes, the sub-field given by the maximum brightness weighting value is arranged at the first part of the frame, that is, at an initial time of a vertical synchronizing interval Vsync. The maximum emission time C is arranged at the initial part of the frame as mentioned above, so that the maximum emission time C in each of the ‘A’, ‘B’ and ‘C’ modes is consistent with each other.

In each of the ‘A’, ‘B’ and ‘C’ modes, sub-fields other than the sub-field given by the maximum brightness weighting value are arranged in a sequence given by lower brightness weighting values as shown in FIG. 7. Alternatively, in each of the ‘A’, ‘B’ and ‘C’ modes, sub-fields other than the sub-field given by the maximum brightness weighting value may be arranged such that the brightness weighting value is continued on a random basis.

As described above, according to the present invention, when a picture is displayed in various modes in which the number of sub-fields and/or the brightness relative ratio are different, the sub-field given by the maximum brightness weighting value is arranged at the first part of the frame to accord the maximum emission time in each mode. Accordingly, it becomes possible to minimizing a moving picture distortion noise. Also, it becomes possible to accord the maximum emission time in each mode to eliminate a flicker causing a variation in brightness of the field, thereby enhancing a display quality.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

What is claimed is:

1. In a method of driving a plasma display panel in which an image of one frame is divided into a plurality of sub-fields each given by a brightness weighting values for its display, a flicker-eliminating method comprising steps of:
setting at least two modes in which at least one of said brightness weighting value and the number of said sub-fields are different from each other; and
arranging said sub-field given by the maximum brightness weighting value at an initial part of the frame in each of said modes.

2. The flicker-eliminating method as claimed in claim 1, wherein sub-fields other than said sub-field given by the maximum brightness weighting value is arranged at a sequence having lower weighting values in each of said modes.

3. The flicker-eliminating method as claimed in claim 1, wherein sub-fields other than said sub-field given by the maximum brightness weighting value have brightness weighting values arranged on a random basis.

4. In a driving apparatus for a plasma display panel in which an image of one frame is divided into a plurality of sub-fields each given by a brightness weighting values for its display, a flicker-eliminating apparatus comprising:
a sub-field mapping unit for mapping an input data using at least two modes in which at least one of said brightness weighting value and the number of said sub-fields are different from each other and said sub-field given by the maximum brightness weighting value is arranged at an initial part of the frame; and
said plasma display panel for displaying a data supplied from the sub-field mapping unit.

5. The flicker-eliminating apparatus as claimed in claim 4, wherein sub-fields other than said sub-field given by the maximum brightness weighting value is arranged at a sequence having lower weighting values in each of said modes.

6. The flicker-eliminating apparatus as claimed in claim 4, wherein sub-fields other than said sub-field given by the maximum brightness weighting value have brightness weighting values arranged on a random basis.
